(19) United States
(12) Patent Application Publication
(10) Pub. No.: US 2017/0357288 A1
(43) Pub. Date: Dec. 14, 2017

(54) DIGITAL DEVICE WITH EXPANDABLE DISPLAY

(71) Applicant: Jean Alexandera Munemann, London (GB)

(72) Inventor: Jean Alexandera Munemann, London (GB)

(21) Appl. No.: 15/177,080

(22) Filed: Jun. 8, 2016

(51) Int. Cl. G06F 1/16; G06F 3/02; H04M 1/02; G06F 3/0484

(52) U.S. Cl. CPC G06F 1/1652; G06F 1/1641; G06F 1/1615; G06F 3/0484; G06F 3/02; H04M 1/0214

(57) ABSTRACT

The present invention relates generally to systems and devices for a computer interface and digital display. The display is designed such that its physical size can be altered based upon the needs of a user. For example, the display may be able to fold or roll up when it is not needed, to allow the device to be more portable, while unfolding or unrolling when additional display area is desired.

### FIELD OF THE INVENTION

The present invention relates generally to systems and devices for a computer interface and digital display.

### BACKGROUND

Generally, electronic devices with digital displays have come in a limited number of form factors. For example, typical cellular telephones may come in a “bar” form factor. These form factors may limit the possible size of a display of the device, such as limiting the display to the diagonal dimensions of the form factor. Therefore, it may be desired to provide devices with other form factors which may allow for larger displays in a smaller device, especially as flexible screen and diode technology advances allow for more dynamic device configurations.

### SUMMARY

In some aspects of the present disclosure, a device is described including a processor. The processor may be a general-purpose processor or a specialty processor, and may include one or more chips or processing units. The device also includes one or more memory modules storing computer code, such as volatile or non-volatile memory, or a combination of both volatile and non-volatile memory. The device also includes a display operably connected to the processor, the display connected to two or more struts, wherein a size of the display is alterable based on a movement of the two or more struts relative to each other. For example, the struts may be horizontal struts as described above, or struts with another orientation. The struts may be attached to a central hinge, to vertical struts (or of another orientation), or in other manners. The struts may have flexible screen between them, where movement of the struts expands or contracts the screen.

The device may include a flexible screen positioned between two struts of the two or more struts, the two struts being movable with respect to one another in order to alter the size of the display. The device may include a display configured to fold up or roll up based upon the movement of the two or more struts relative to each other. The device may have two or more struts are attached to a central hinge and the size of the display may be alterable by movement of the two or more struts around the central hinge. The display may be circular or semi-circular. The device may be a cellular telephone, with a microphone and a speaker. The size of the display may be altered by movement of the two or more struts relative to each other, the two or more struts may be moved by an electrical, mechanical, or magnetic force. The display may be one of a graphene-based flexible display, a flexible organic light-emitting diode display, or a phase-change material display. The device may also include a handle with one or more control buttons.

In one aspect of this disclosure, a device including a processor and one or more memory modules storing computer code is described. The device includes an expandable display screen, the screen configured to expand or contract a physical size of the screen based on an input from a user. The display may be a flexible screen positioned between two struts, the two struts being movable with respect to one another in order to alter the size of the display. A portion of the display may be configured to fold up or roll up based upon the movement of two or more struts relative to each other. Two or more portions of the display may be attached to a central hinge and the size of the display may be alterable by movement of the two or more portions. The device may be a cellular telephone, which may include a microphone and a speaker. The display may be one of a graphene-based flexible display, a flexible organic light-emitting diode display, or a phase-change material display.

Another aspect of the present disclosure includes a device with a processor or a communication channel to communicate with a process for obtaining a representation or reference to a display image. The device also has a plurality of struts, wherein the plurality of struts are movable from a first state to a second state and optical pixel elements on the plurality of struts that are controllable by the display device to permit presentation of all or part of the display image using the optical pixel elements within a display region of the display device, wherein the display region varies between the first state and the second state and the display region spans the plurality of struts.

In some aspects, the display device also includes a flexible screen element attached between two struts of the plurality of struts, the two struts being movable with respect to one another in order to alter the display region. The flexible screen element may include optical pixel elements, thereby forming the display region to span the flexible screen element and the two struts.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an exemplary illustration of a computer device with a folding display according to some aspects of the present disclosure.

FIG. 2 is another exemplary illustration of a computer device with a folding display according to some aspects of the present disclosure.

FIG. 3 is an exemplary illustration of a computer device with a folding display according to some aspects of the present disclosure with an alternative wire location.

FIG. 4 is an exemplary illustration of a computer device with a handheld folding display according to some aspects of the present disclosure.

FIG. 5 is an exemplary illustration of another embodiment of a device that includes a central support strut and drop side struts.

FIG. 6 is another exemplary illustration of another embodiment of a device that includes a central support strut and drop side struts.

FIG. 7 is another exemplary illustration of another embodiment of a device that includes a central support strut and drop side struts.

FIG. 8 illustrates a device that includes a horizontally-opening handle.

FIG. 9 illustrates a device according to some aspects described herein that includes a second hinged handle.

FIG. 10 illustrated a device in which the handle opens vertically from the device.

FIG. 11 illustrates a device in which the screen has been fully opened.

FIG. 12 illustrates a device according to some aspects of the present disclosure.

FIG. 13 is an alternative configured of a device according to some aspects of the present disclosure.

FIG. 14 is an alternative configured of a device according to some aspects of the present disclosure.

FIG. 15 in exemplary illustration of an alternative embodiment of a device according to some aspects of the present disclosure.

FIG. 16 is another viewpoint of a device according to some aspects of this disclosure.

FIG. 17 is an illustration of a device according to some aspects of the present disclosure.

FIG. 18 is another illustration of a device according to some aspects of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present invention might find a use in presenting information to users of digital devices. Examples of digital devices, while not limiting, include tablet computers, portable phones, laptop computers, pedometers, watches and the like. Such digital devices typically include some logic circuits and/or a processor that executes a stored set of instructions to perform some actions. Some of those actions might relate to presenting a display image to a user of the digital device. To be more precise, the digital device includes logic or instructions that, when executed, determine that a particular display image is to be presented to the user and communicates that display image, or a reference to it or a representation of it, to a display element, also referred to herein as “a display.” The display image might be regularly refreshed and/or changed, for example when the digital device attempts to present a video image. The display element may be equipped with means and methods for communicating with the digital device, wired or wirelessly, such that the digital device can convey a desired digital image to the display element and the display element can attempt to present that desired digital image for user viewing. The display element might also be configured to convey to the logic/processor a state of the display element.

The display element has an ability to present the display image, or at least parts of it, within certain constraints of the display element. Herein, the area over which a display image can be presented is referred to as a “display region” for the display element. The display region might be rectangular or not. The display region may vary based on the state of the display element. In some embodiments, the digital device includes logic or programming to alter the display image to account for the state of the display element. The display element might have a defined footprint corresponding to the space or area that the display element occupies when in a given state. For example, a display element might have a display region that is a rectangle 6 cm by 10.5 cm and a footprint of 6.5 cm by 14 cm.

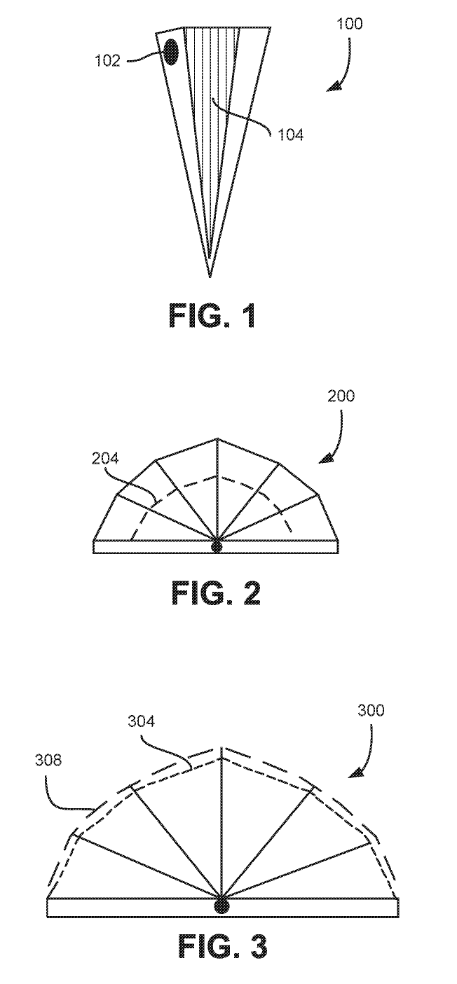

FIG. 1 is an exemplary illustration of a folding display 100 for use with a digital device, according to some aspects of the present disclosure. As illustrated, the folding display 100 may be shaped similarly to a handheld folding fan. In FIG. 1, the folding display 100 is illustrated in a “folded up” position or state. Foldable and other soft screen technologies may allow for the creation of display elements in a vast array of different footprints and display regions. In order to allow a device to include as large a display region as possible, and to provide an array of different features that will become clear in light of this disclosure, a fan-shaped form factor for the display element may be beneficial. Instead of a folded display, a rolled up display might be used. Unless otherwise indicated, teachings herein related to folded displays can be applied to rolled up displays.

It may be advantageous to allow a display to fold or roll or otherwise be altered in size, in comparison to conventional displays that maintain the same size at all times. For example, many conventional cellular phones are in a “candy bar” format, i.e., a large rectangle. To increase the size of the screen shape, the size of the rectangle of the device must be increased, but such an increase in size may negatively affect users of the device, who may not wish to carry around such a bulky device. Accordingly, expandable displays, such as displays that can fold or roll up, may allow for larger display regions in more convenient form factors. This combination of portability and display region may be desirable to some users.

As illustrated, the folding display 100 contains a number of internal struts 104. The display region, or the edges of the display region, may be visible even when the folding display 100 is folded up at these locations, such as the corner of a folded location. It may be beneficial to place controls for common functions on these internal struts 104, such as to allow the taking of photographs without unfolding the entire folding display 100, or to use the folding display 100 as a telephone interface without unfolding the entire folding display 100. The folding display 100 may also include one or more exterior buttons 102, which may be used for performing functions such as turning on or off an associated digital device, allowing the display to fold out, or to take photographs, use as a phone, or enable other functions. The associated digital device might be integrated with the folding display 100 or might be wired or wirelessly connected to the folding display 100 and be a separately housed unit (not shown in FIG. 1) Functions of the folding display may be split between internal struts 104 and exterior buttons 102, as desired, based upon a preference of the user and based on how commonly used a particular function is. For example, it may be advantageous to place more commonly-used functions on buttons that are more accessible to a user. It may also be advantageous to have a touch-sensitive “skin” on the frame of the folding display 100 rather than a button, where the skin may enable a knock code or fingerprint activation.

FIG. 2 is an exemplary illustration of a folding display 200 according to some aspects of the present disclosure. The folding display 200 in FIG. 2 may be similar to the folding display 100 of FIG. 1, but here, the folding display 200 is in an “unfolded” state. Dashed line 204 illustrates a possible location of a wire in the center of the fan-shaped screen formed by the folding display 200 in its unfolded state. This wire may be used, for example, to control when the screen is folded or unfolded. A tape or a cord might be used instead of the wire. The wire may be placed behind the screen, in order to minimize interference with viewing a display image presented on the screen of the folding display 200. In some aspects, the folding display may instead be rolled up rather than folded. The wire may also be used to provide power to the folding display, used as a handle, or used for other functions.

FIG. 3 is an exemplary illustration of a folding display 300 according to some aspects of the present disclosure, where the wire is placed in a different location than that shown in FIG. 2. In FIG. 3, the screen of folding display 300 is “unfolded,” and dashed line 308 illustrates another possible location of a wire around the screen. This wire may be used, for example, to control when the fan is folded or unfolded. A tape or a cord might be used instead of the wire. Here, the screen may be bonded to the retracting wire at the location of the dashed line 304. The wire may be adjusted, to change the display region by altering the state of the fan, using electrical, mechanical, and/or magnetic winding systems or other techniques. For example, the folding display 300 may also use air pressure along a structural support line to act as a frame of the device, rather than using wire to control when the display to folded or unfolded.

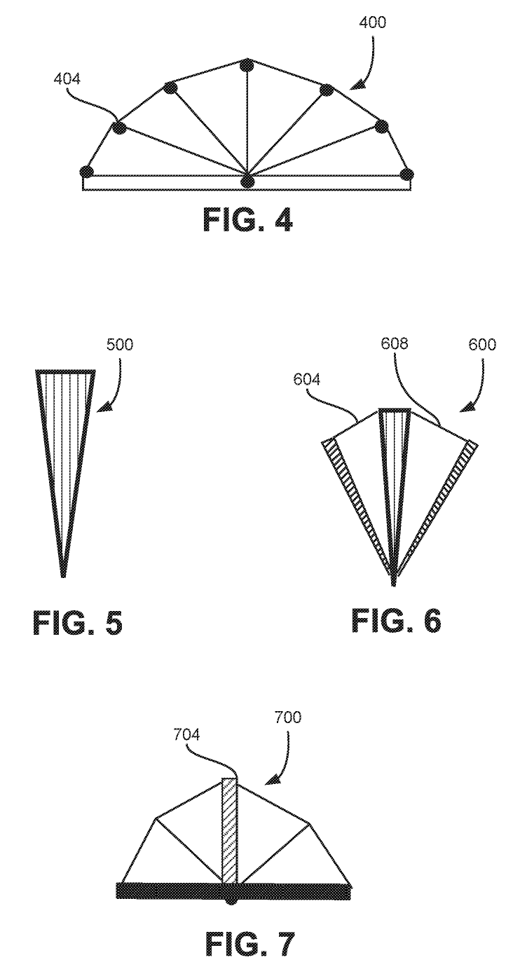

FIG. 4 is an exemplary illustration of a folding display 400 according to some aspects of the present disclosure. The folding display 400 may include a number of electrically triggered magnets 404, illustrated with dark circles at the edge of the various internal struts of the display. These magnets 404 may be used to retract and to expand the screen, as is desired by a user of the folding display 400. The magnets 404 may be part of an electrical magnetic winding system to open and close the footprint and display region of the folding display 400. In some aspects, other winding systems may also be used, such as a mechanical system or an electric system. For example, the magnets 404 in FIG. 4 may be used in conjunction with the wire found in FIGS. 2 and 3, such that the magnets 404 may control a wire or other mechanism for opening and closing the folding display 400 in order to adjust the display region.

FIG. 5 is an exemplary illustration of another embodiment of a folding display 500 that includes a central support strut and drop side struts. In this illustration, the folding display 500 is in the closed position. In some aspects, components of a digital device associated with the folding display 500 may be in external support struts at the edge of the folding display 500, or in a central control strut at the center of the folding display 500, and within internal struts. These struts may contain the main user interface of the device 500, such as cameras and speakers, which may be accessed fully even if the folding display 500 is closed. In this mode, the folding display 500 may be used as if it were a long and narrow display, until a user requires a larger display area. In some aspects, the portions of the display region that are between the struts may be concertina-folded like a classical fan, or may be rolled into the struts themselves. The folding display 500 may also include a processor and memory and other components, which may also be in one or more struts of the device.

FIG. 6 is an exemplary illustration of another embodiment of a folding display 600 that includes a central support strut and drop side struts. In this illustration, the folding display 600 has only the two side struts 604, 608 open. As illustrated, the folding display 600 may have only a subset of the struts open, here the struts 604, 608, while other parts are closed. This may allow the folding display 600 to have a large number of possible viewing configurations, depending on the needs of a user at a particular time. Thus, a user may choose a desired screen size for a particular application or other considerations.

FIG. 7 is another exemplary illustration of an embodiment of a folding display 700 that includes a central support strut and drop side struts. In this illustration, the folding display 700 is half open, and the center support strut 704 remains closed. As illustrated, the display region of the folding display 700 may open into a shape that is more than a half-circle, such as opening to be fully circular or to be approximately three-quarters of a circle.

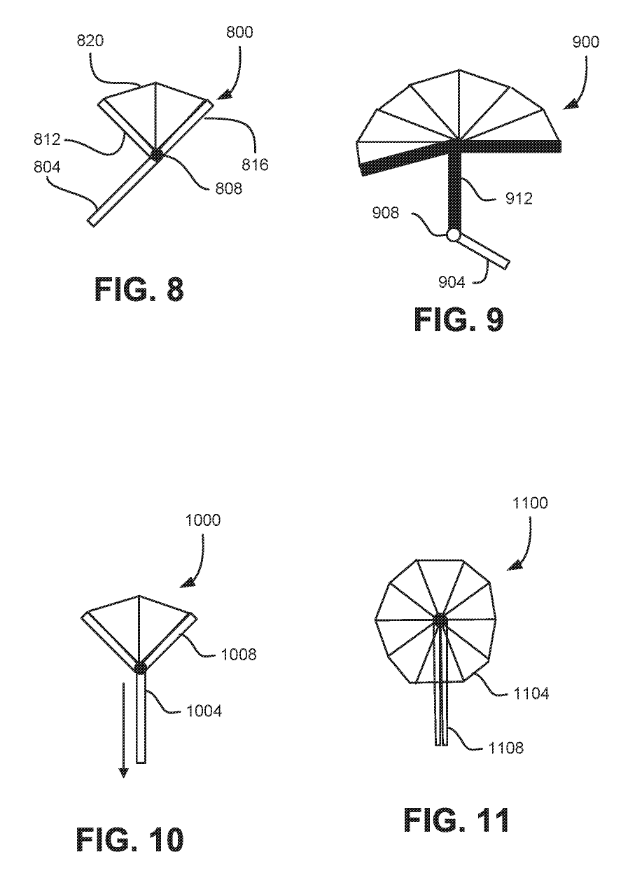

The folding display may or may not have a handle. FIG. 8 illustrates a folding display 800 that includes a horizontally-opening handle 804. The handle 804 is attached to the folding display 800 using a hinge 808. The hinge 808 allows the handle to either be placed adjacent to one of the struts 812, 816 or to swing open into a position to allow a user to grasp the handle 804. When the handle 804 is not needed or the folding display 800 is not in use, the hinge 808 allows the handle 804 to “close”, by swinging the handle 804 to be concealed near or around one of the struts 812, 816. As with other devices described herein, the display region 820 of the folding display 800 may be concealed within or between the struts 812, 816 when not in use, and may unroll or unfold from between the struts 812, 816 when needed. Here, the display region 820 may be only partly opened, in order to provide as large a screen as a user might need for a particular usage of the folding display 800.

FIG. 9 illustrates a folding display 900, according to some aspects described herein, that includes a second hinged handle 904. This folding display 900 may be similar to the folding display 800 in FIG. 8, but here, a second hinged handle 904 is included that opens from a hinge 908 connected to the end of a first handle 912. Other types of handles may also be used, with various connections. The handle may include one, two, or more parts, as desired. Including a handle with multiple parts may be advantageous for some users who wish to have more flexibility in how the folding display 900 is kept in position. For example, the handles may be configured to rest on a surface in order to hold the folding display 900 up without requiring a user to continue holding the folding display 900.

FIG. 10 illustrated a folding display 1000 in which the handle 1004 opens vertically from the folding display 1000. For example, the handle 1004 may be configured to slide into or around a strut 1008 of the folding display 1000. The handle 1004 may slide into and out of the folding display 1000 in a vertical manner, rather than around a hinge as described above. This may be an alternative manner of providing a convenient handle 1004 for the folding display 1000. The handle 1004 may be slid vertically either manually, or using an electrical, mechanical, magnetic, or other automated mechanism.

FIG. 11 illustrates a folding display 1100 in which the display region 1104 has been fully opened. As illustrated, the display region 1104 may be configured to open into a full circular shape. The display region 1104 may be smaller than the handle 1108, in order to allow the handle 1108 to still be used when the display region 1104 is open. The screen 1104, as illustrated, is also configured to open in front of the handle 1108, in order to allow a user to view the display region 1104 without the handle 1108 obscuring the view.

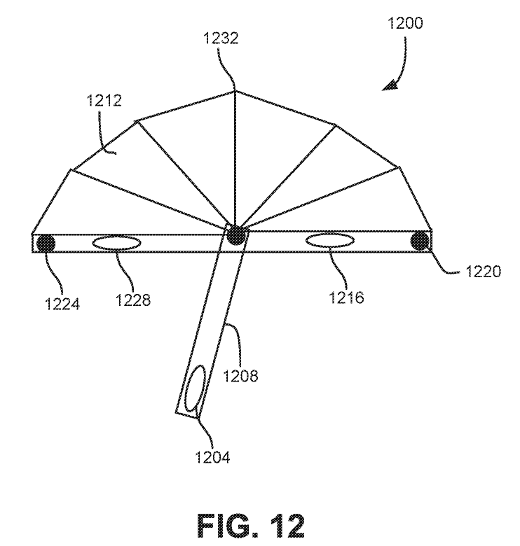

FIG. 12 illustrates a folding display 1200 according to some aspects of the present disclosure. The folding display 1200 includes control buttons 1204 on its handle 1208. The control buttons 1204 may offer a convenient user interface, whether the folding display 1200 is open or closed. The buttons 1200 may control operation of various functions of the device, such as opening or closing the display region 1212, turning on and off the microphone 1216, and may help to control various functions which may be offered by the folding display 1200, such as use of the camera 1220 and the projector 1224. The folding display 1200 also includes a speaker 1228 which itself is held in place using a number of support struts 1232.

The folding display 1200 may be a flexible display area, such as a “Plastic Logic” graphene-based flexible display, one or more flexible organic light-emitting diodes (OLEDs), or an ultra-low-power phase-change material. In some aspects, other display types may also be used provided that they are a suitable resolution and are able to be fit into the desired form factor. Specifically, the display region 1212 should be configured to be extended from the struts of the folding display 1200, and should be able to be either folded up or rolled up, when the folding display 1200 is not in use.

In some aspects, the folding display 1200 incorporates a digital device, which includes a processor, a power source, such as a battery, and storage that includes a database. For example, the storage may take the form of a memory, including one or both of volatile and non-volatile memory. As described above, in one aspect, these components may be contained in a strut of the folding display 1200. The display region 1212 may include a touch screen, such as a resistive or capacitive touch screen. The folding display 1200 may include Wi-Fi support, such as support for one or more IEEE 802.11 protocols. As illustrated, the folding display 1200 may include a speaker 1228, a projector 1224, a microphone 1216, and/or a camera 1220. The folding display 1200 may be configured to use inductive charging, to be able to charge its battery using wireless charging techniques. The folding display 1200 may include one or more antennas, in able to allow the folding display 1200 to communicate using cellular and/or Wi-Fi communications, as well as Bluetooth and other wireless communications protocols.

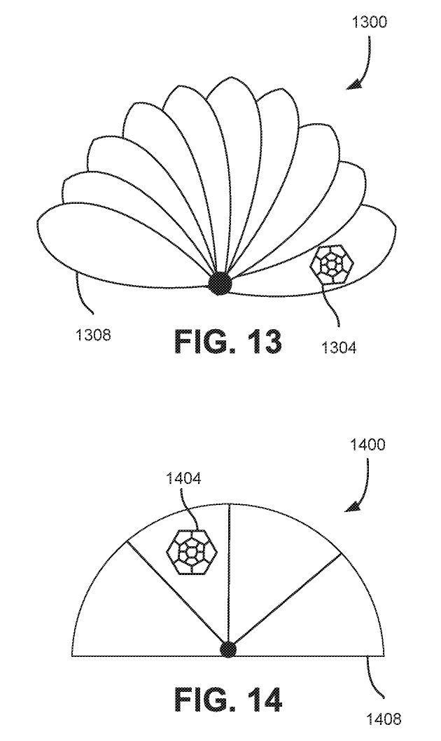

FIG. 13 is an alternative configuration of a folding display 1300 according to some aspects of the present disclosure. The folding display 1300 may not contain struts, and instead, the folding display 1300 may include computer components of a digital device, such as a processor, memory, and other components in one of the “leaves” of the folding display 1300. The folding display 1300 may include a user interface 1304, which may include a number of physical or software buttons, on one of the “leaves” of the folding display 1300 as well. Each “leaf” of the folding display 1300 may be attached to the central hinge 1312, which may allow the “leaves” to be used to adjust the size of the display region 1308 as desired.

FIG. 14 is an alternative configured of a folding display 1400 according to some aspects of the present disclosure. The folding display 1400 may not contain struts, and instead, the folding display 1400 may include digital device components, such as a processor, memory, and other components in one of the portions of the folding display 1400. The folding display 1400 may include a user interface 1404, which may include a number of physical or software buttons, on one of the portions of the display region 1408 as well.

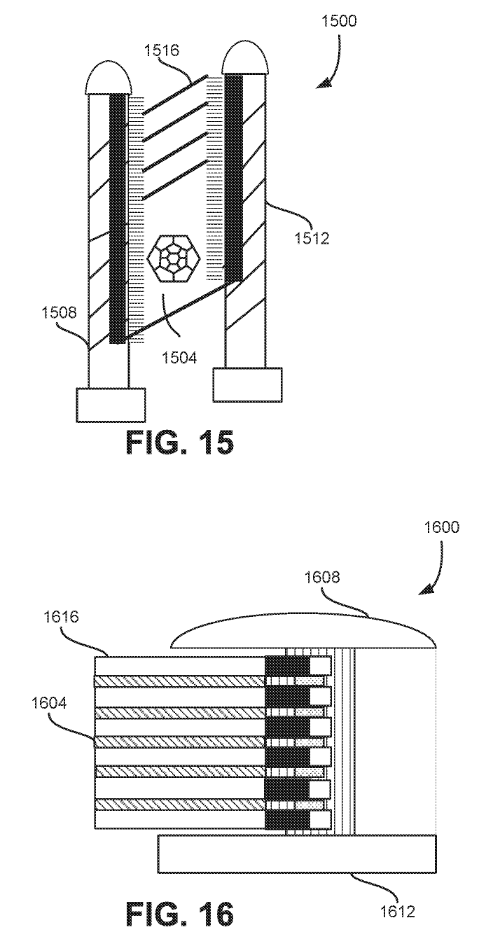

FIG. 15 in exemplary illustration of an alternative embodiment of a folding display 1500 according to some aspects of the present disclosure. The folding display 1500 includes a display region 1504 that extends between two vertical struts 1508, 1512. The folding display 1500 can be folded up, as illustrated in the upper portion of the folding display 1500, between one or more horizontal struts 1516. These horizontal struts 1516 move further apart from one another, such as by using an electrical or mechanical mechanism to move them apart, in order to expand the folding display 1500 and offer a larger display region 1504. The folding display 1500 may include components of a digital device, such as a processor and memory, in one of the vertical struts 1508, 1512. Alternatively, the folding display 1500 may be connected to an external digital device.

FIG. 16 is another viewpoint of a folding display 1600 according to some aspects of this disclosure. In this illustration, the folding display 1600 is folded up or rolled up between one or more horizontal struts 1616. The folding display 1600 also includes vertical struts 1608, 1612, to the side of the horizontal struts 1616. The display region 1604 may fold or roll up between the horizontal struts 1616 when it is not needed. The folding display 1600 may include components of a digital device, which may be found in the vertical struts 1608, 1612. As illustrated, folding display 1600 may include two vertical struts 1608, 1612, and between those two vertical struts 1608, 1612, horizontal struts 1616 contain the display region 1604. The horizontal struts 1616 may be movable with respect to each other and the vertical struts 1608, 1612, and may therefore increase or decrease the size of the display region 1604 accordingly.

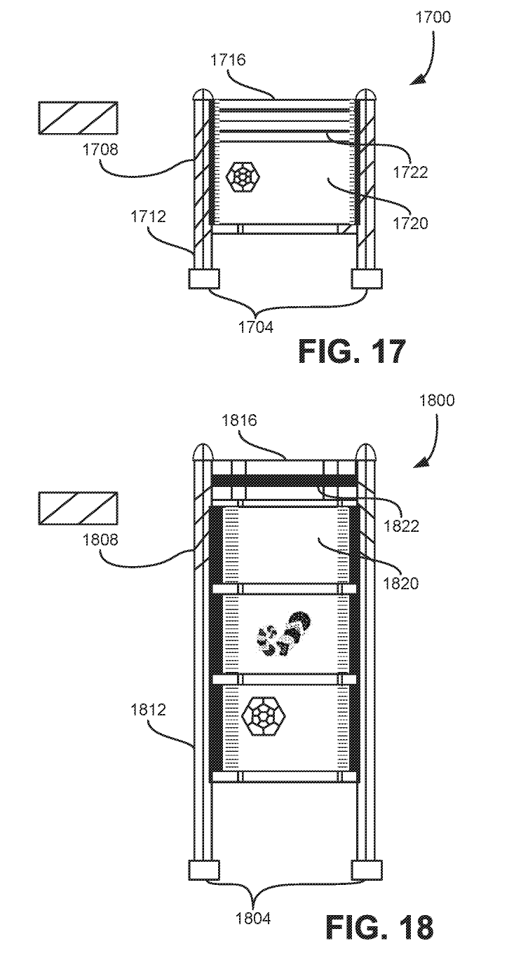

FIG. 17 is an illustration of a folding display 1700 according to some aspects of the present disclosure. The folding display 1700 includes retractable vertical struts 1704. Here, the crosshatched area of the vertical struts is the stable portion 1708 of the vertical struts 1704 that cannot be retracted further. The stable portion 1708 of the vertical struts 1704 may contain hardware of a digital device, such as a processor and memory. As illustrated in FIG. 17, the retractable portion 1712 of the vertical struts 1704 may be retracted, such as into the vertical struts 1704 themselves. Horizontal support struts 1716 extended between the vertical struts 1704, and a flexible display region 1720 is placed between the horizontal support struts 1716. The display region 1720 may roll or fold up between the horizontal support struts 1716 when they are closed, and extend between the horizontal support struts 1716 when they are open. For example, the display region 1720 may fold like an accordion between the horizontal support struts 1716. Folding display 1700 may be compact, as the folding display 1700 may be made smaller by retracting the retractable portion 1712 of the vertical struts 1704 and closing the display region 1720 by moving the horizontal support struts 1716 together, through the use of a mechanical, electrical, magnetic, or other mechanism. Folded parts 1722 of the display region 1720 may be between the horizontal support struts 1716 that are not expanded.

FIG. 18 is another illustration of a folding display 1800 according to some aspects of the present disclosure. The folding display 1800 in FIG. 18 is similar to the folding display 1700 in FIG. 17, but here, the retractable struts 1804 are extended. This allows the horizontal support struts 1816 to be spread apart, and increases the size of the display region 1820. A user may be able to extend the folding display 1800 as desired, in order to take up more or less space. The folding display 1800 may fold like an accordion, such as using micro-hinges on the screen to fold up into a compact position 1822 when the horizontal support struts 1816 are close together.

In some aspects of the present disclosure, a device is described including a processor. The processor may be a general-purpose processor or a specialty processor, and may include one or more chips or processing units. The device also includes one or more memory modules storing computer code, such as volatile or non-volatile memory, or a combination of both volatile and non-volatile memory. The device also includes a display operably connected to the processor, the display connected to two or more struts, wherein a size of the display is alterable based on a movement of the two or more struts relative to each other. For example, the struts may be horizontal struts as described above, or struts with another orientation. The struts may be attached to a central hinge, to vertical struts (or of another orientation), or in other manners. The struts may have flexible screen between them, where movement of the struts expands or contracts the screen.

The device may include a flexible screen positioned between two struts of the two or more struts, the two struts being movable with respect to one another in order to alter the size of the display. The device may include a display configured to fold up or roll up based upon the movement of the two or more struts relative to each other. The device may have two or more struts are attached to a central hinge and the size of the display may be alterable by movement of the two or more struts around the central hinge. The display may be circular or semi-circular. The device may be a cellular telephone, with a microphone and a speaker. The size of the display may be altered by movement of the two or more struts relative to each other, the two or more struts may be moved by an electrical, mechanical, or magnetic force. The display may be one of a graphene-based flexible display, a flexible organic light-emitting diode display, or a phase-change material display.

In one aspect of this disclosure, a device including a processor and one or more memory modules storing computer code is described. The device includes an expandable display screen, the screen configured to expand or contract a physical size of the screen based on an input from a user. The display may be a flexible screen positioned between two struts, the two struts being movable with respect to one another in order to alter the size of the display. A portion of the display may be configured to fold up or roll up based upon the movement of two or more struts relative to each other. Two or more portions of the display may be attached to a central hinge and the size of the display may be alterable by movement of the two or more portions. The device may be a cellular telephone, which may include a microphone and a speaker. The display may be one of a graphene-based flexible display, a flexible organic light-emitting diode display, or a phase-change material display.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

1. A device comprising:
a processor;
one or more memory modules storing computer code; and
a display element operably connected to the processor, the display element connected to two or more struts, wherein a size of a display region over which the display element can present a display image is alterable based on a movement of the two or more struts relative to each other.

2. The device of claim 1, wherein the display includes a flexible screen positioned between two struts of the two or more struts, the two struts being movable with respect to one another in order to alter a size of the display region.

3. The device of claim 1, wherein at least a portion of the display element is configured to fold up or roll up based upon movement of the two or more struts relative to each other.

4. The device of claim 1, wherein the two or more struts are attached to a central hinge and the size of the display region is alterable by movement of the two or more struts around the central hinge.

5. The device of claim 4, wherein the display region is circular or semi-circular.

6. The device of claim 1, wherein the device is a cellular telephone, the device further comprising a microphone and a speaker.

7. The device of claim 1, wherein the two or more struts are moveable relative to each other by an electrical, mechanical, or magnetic force.

8. The device of claim 1, wherein the display element is one of a graphene-based flexible display, a flexible organic light-emitting diode display, or a phase-change material display.

9. The device of claim 1, further comprising a handle with one or more control buttons.

10. A device comprising:
a processor;
one or more memory modules storing computer code; and
an expandable display screen, the screen configured to expand or contract a physical size of the expandable display screen based on an input from a user.

11. The device of claim 10, wherein the expandable display screen includes a flexible screen positioned between two struts, the two struts being movable with respect to one another in order to alter the physical size of a display region over which the expandable display screen can present a display image.

12. The device of claim 11, wherein at least a portion of the expandable display screen is configured to fold up or roll up based upon movement of the two struts relative to each other.

13. The device of claim 11, wherein the two struts are attached to a central hinge and the physical size of the display region is alterable by movement of the two struts.

14. The device of claim 10, wherein the device is a cellular telephone, the device further comprising a microphone and a speaker.

15. The device of claim 10, wherein the expandable display screen is one of a graphene-based flexible display, a flexible organic light-emitting diode display, or a phase-change material display.

16. A device comprising:
a processor or a communication channel to communicate with a process for obtaining a representation or reference to a display image;
a plurality of struts, wherein the plurality of struts are movable from a first state to a second state; and
optical pixel elements on the plurality of struts that are controllable by the device to permit presentation of all or part of the display image using the optical pixel elements within a display region of the device, wherein the display region varies between the first state and the second state and the display region spans the plurality of struts.

17. The device of claim 16, wherein the device further comprises a flexible screen element attached between two struts of the plurality of struts, the two struts being movable with respect to one another in order to alter the display region, wherein the a flexible screen element includes optical pixel elements, thereby forming the display region to span the flexible screen element and the two struts.
